(19) United States
(12) Patent Application Publication
(10) Pub. No.: US 2005/0076315 A1
(43) Pub. Date: Apr. 7, 2005

(54) Modularized circuit design information generating method, modularized circuit design information generating tool and integrated circuit prepared with circuit design information generated therefrom

(76) Inventor: Kuei-Ann Wen, HsinChu (TW)

Correspondence Address: Pavel Pogodin, 617 North Delaware Street, San Mateo, CA, 94401, US

(21) Appl. No.: 10/678,375

(22) Filed: Oct. 3, 2003

(51) Int. Cl. G06F 17/50

(52) U.S. Cl. 716/1

(57) ABSTRACT

Modularized circuit design information generating tool comprises: a circuit module design database including circuit design information of functional modules of at least two categories, wherein at least one category of said functional modules includes design information of circuit modules of at least two different specifications; an element selection means to select suited circuit modules from said circuit module design database according to particular specifications of functional elements to be included into circuit to be designed and to include circuit design information corresponding to said selected circuit modules into circuit design information file of said circuit to be designed; a circuit module connection means to define connections between or among selected circuit modules according to features of each selected circuit module; a memory to store circuit design information of all selected circuit modules and information of connections between and/or among the selected circuit modules, both of circuit under design or circuit as designed; and a file converting means to convert circuit design information so obtained into an applicable format. The invention provides a modularized circuit design information generating method using the tool and the integrated circuit prepared using the circuit design information so generated.

### FIELD OF THE INVENTION

The present invention relates to modularized circuit design information generating method, modularized circuit design information generating tool and integrated circuit prepared with circuit design information generated therefrom.

### BACKGROUND OF THE INVENTION

In the design of integrated circuit, to design a working circuit in a modularized manner has been a well-accepted approach. Especially in the era of “information technology”, to supply circuit designs to circuit designers has become a new profession. As a result, to include module by module circuit design information supplied by another into a working circuit to be designed has become a new trend of in the design of working circuits.

Although there are many circuit design tools commercially available in the industry, these circuit design tools don't provide users (designers) the function of composing a number of available Circuit modules into an optimal combination of the finite circuit modules based on the features, requirements and other conditions of the working circuit to be designed.

In addition, when a working circuit is to be designed, several conditions and requirements will be applied to the working circuit. These conditions and requirements include: power consumption, size of dice, operational speed, capacity of memory etc. However, when a working circuit shall be designed in a modularized manner, the conventional circuit design tools do not provide the function of allowing users to comply with these conditions and requirements when the working circuit is under design.

It is thus necessary to provide a modularized circuit design information generating method to allow circuit designers to configure suited circuit modules into an optimal circuit design under definite conditions.

It is also necessary to provide a modularized circuit design information generating method to allow circuit designers to design circuits that meet particular requirements.

It is also necessary to provide a modularized circuit design information generating tool to allow circuit designers to design modularized circuits with ease and convenience.

### OBJECTIVES OF THE INVENTION

The objective of this invention is to provide a modularized circuit design information generating method to allow circuit designers to configure suited circuit modules into an optimal circuit design under definite conditions.

Another objective of this invention is to provide a modularized circuit design information generating method to allow circuit designers to design circuits that meet particular requirements.

Another objective of this invention is to provide a modularized circuit design information generating tool to allow circuit designers to design modularized circuits with ease and convenience.

Another objective of this invention is to provide integrated circuits prepared according to the circuit design information generated by the above method and tool.

### SUMMARY OF THE INVENTION

According to this invention, a modularized circuit design information generating method and a modularized circuit design information generating tool is provided. The modularized circuit design information generating tool of this invention comprises: a circuit module design database including circuit design information of functional modules of at least two categories, wherein at least one category of said functional modules includes design information of circuit modules of at least two different specifications; an element selection means to select suited circuit modules from said circuit module design database according to particular specifications of functional elements to be included into circuit to be designed and to include circuit design information corresponding to said selected circuit modules into circuit design information file of said circuit to be designed; a circuit module connection means to define connections between or among selected circuit modules according to features of each selected circuit module; a memory to store circuit design information of all selected circuit modules and information of connections between and/or among the selected circuit modules, both of circuit under design or circuit as designed; and a file converting means to convert circuit design information so obtained into an applicable format.

These and other objectives and advantages of this invention may be clearly understood from the detailed description by referring to the following drawings.

### BRIEF DESCRIPTION OF THE DRAWINGS

FIG. 1 illustrates the block diagram of a typical working circuit.

FIG. 2 illustrates the systematic diagram of the modularized circuit design information generating tool of this invention.

FIG. 3 illustrates the flowchart of the modularized circuit design information generating method of this invention.

FIG. 4 shows the block diagram of a working circuit designed according to the modularized circuit design information generating method of this invention.

FIG. 5 illustrates a block diagram of a Bluetooth working circuit designed by the modularized circuit design information generating tool of this invention.

FIG. 6 illustrates the block diagram of a wireless networking circuit designed with the modularized circuit design information generating tool.

FIG. 7 shows a list of functional modules and circuit modules used in the circuit of FIG. 6.

### DETAILED DESCRIPTION OF THE INVENTION

In the followings, detailed description for the invented modularized circuit design information generating method and modularized circuit design information generating tool will be given by referring to the drawings.

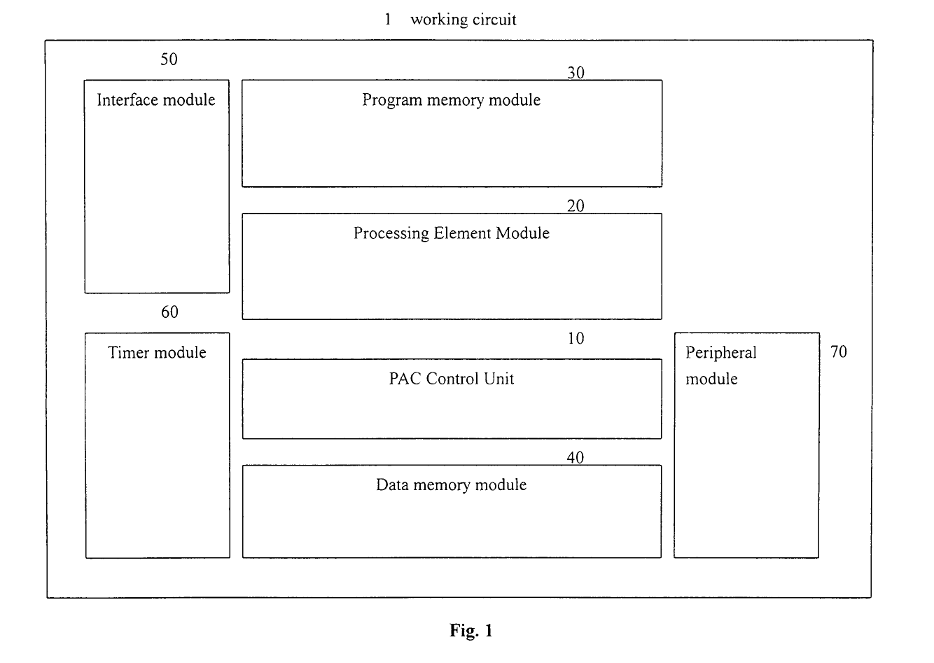

FIG. 1 illustrates the block diagram of a typical working circuit. In this figure, shown is the basic structure of a working circuit commonly seen in all kinds of application. Such a working circuit may be a central processing unit, a data processor used in the application of telecommunications, a controller used in any peripheral machine etc. The working circuit 1 as shown in FIG. 1 includes: a control unit 10 to control the operations of all the modules in the working circuit 1; a processing element unit 20 to execute all kinds of signal processing and data processing in the working circuit 1; a program memory module 30 to store all kinds of system software and application programs; a data memory module 40 to store or temporarily store data needed or generated from all kinds of operation in the working circuit; an interface module 50 to enable data exchange and communications and control between the working circuit 1 and all kinds of external machines and users; a timer module 60 to provide all kinds of clock signals needed in the operation of the working circuit; and a peripheral module 70 to provide all kinds of interfaces to allow the data exchange and communications and control between the working circuit 1 and its peripherals. In the followings, all these modules, units will be called “functional modules” collectively and “functional module” separately.

In general, a working circuit may include all or some categories of the above-mentioned functional modules; In a working circuit, a plurality of functional modules belonging to one category may be included, depending on the need in the application.

When a designer is planning or designing a working circuit, the functional modules needed in the working circuit may include those designed by the designer and those designed by other designers or professional intellectual property (IP) providers. If a functional module is designed by a third party, it is necessary for the designer to obtain a license from the third party and to conduct necessary modifications to the circuit design information provided by the third party, such that the third-party circuit design information may be included into the design information of the working circuit. Such an approach is able to shorten the time spent in the design of the working circuit.

For example, in the field of the central processing unit, design information of varies types of central processing unit is commercially available in the market, ready for licensing to designers of circuits. This includes ARM7TDMI® core circuit design (by ARM Ltd.), MIPS32™ core circuit design (by MIPS Technologies, Ltd.) etc. Any designer may include the design information of any of the central processing unit into the working circuit designed by the designer to provide desired functionalities after a license from the design information provided is obtained.

In addition, in the field of the memory circuit, several types of memory are available for license in the market. They include: W981616BH (1M×16/143 MHz) (by Winbond Electronics Corp.), V54C3′6′62V (1M×16/143 MHz/3.3V) (by Mosel Vitelic Inc.) etc.

Similarly, interfacing modules such as USB2.0 PHY IP (by Faraday Technology Corporation), IEEE1394 IP (by Faraday Technology Corporation) etc. are openly licensed to designers. Timer modules such as 555 Timer IC (by the Signetics Corporation), SN52555 (Texas Instruments Incorporated) etc. are offered for license. Peripheral circuit modules such as MT1326, MT1328 (by MediaTek Inc.) are good choices of ordinary designers. These and other commercially available circuit modules help designers to shorten their design time and reduce their design costs.

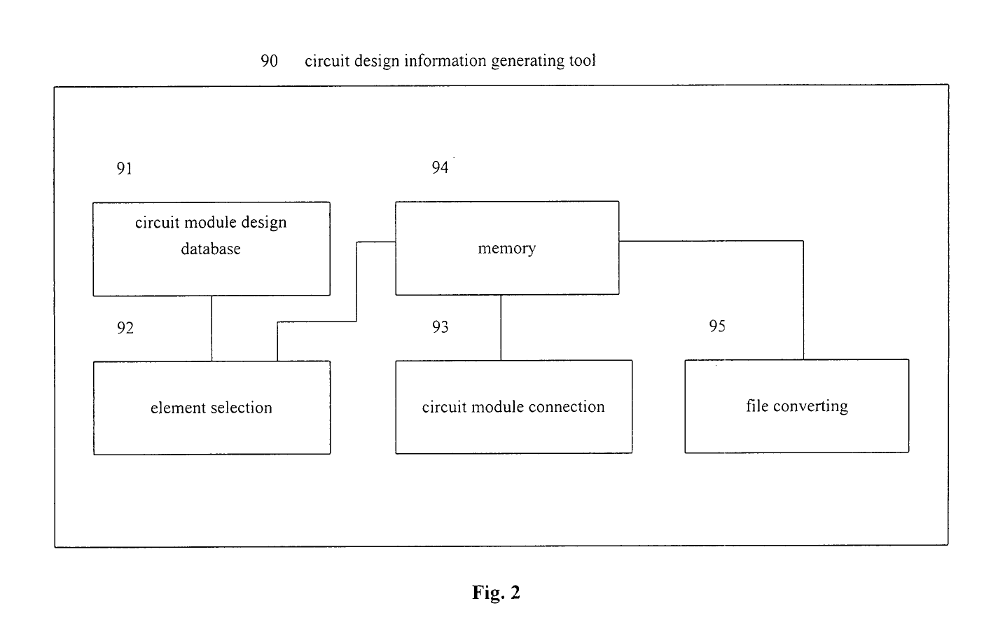

The present invention provides a novel modularized circuit design information generating tool. FIG. 2 illustrates the systematic diagram of the modularized circuit design information generating tool of this invention. As shown in this figure, the modularized circuit design information generating tool 90 of this invention comprises a circuit module design database 91 to include circuit design information of functional modules of at least two categories, wherein at least one category of said functional modules includes design information of circuit modules of at least two different specifications; an element selection means 92 to select suited circuit modules from said circuit module design database according to particular specifications of functional elements to be included into circuit to be designed and to include circuit design information corresponding to said selected circuit modules into circuit design information file of said circuit to be designed; a circuit module connection means 93 to define connections between or among selected circuit modules according to features of each selected circuit module; a memory 94 to store circuit design information of all selected circuit modules and information of connections between and/or among the selected circuit modules, both of circuit under design or circuit as designed; and a file converting means 95 to convert circuit design information so obtained into an applicable format.

In the circuit module design database 91, design information of all kinds of necessary functional modules is stored. These functional modules include: central processing unit, processing elements, program memory, data memory, interfacing circuits, timer circuits, peripheral circuits and other functional modules. In the present invention, each category of functional module may include circuit design information of circuit module of different types or specifications. For example:

Central processing unit may be classified according to its specification. As a result, design information for central processing unit may be classified according to its operational speed, length of instruction, width of bus etc. Processing elements may be classified based on their functions. They may be classified into codec, filter, modulator etc. Memory may be classified according to its capacity and structure. So we have SRAM, DRAM etc. modules with different memory space design. Interfacing circuits which design information is included may be classified according to their interfacing standards and may include A/D converter, D/A converter, USB interface, PCMCIA interface etc.

As to peripheral circuits, several types may be classified according to their functions and may include video processor, audio visual processor, biochip etc.

In order to satisfy the needs in the design of all kinds of application circuits, the modularized circuit design information generating tool of this invention provides design information of a variety of processing elements in the circuit module design database 91. These processing elements include: program cache or program memory, program fetch circuit, control register, instruction dispatch circuit, control logics, instruction decoder, test circuit, ALU, emulation circuit, register, interrupt circuit and data cache or data memory. A processing element may also be a combination of all or a part of these circuits. A portion of circuits needed in a processing element may also be those belonging to another functional module. As a result, processing elements which design information is stored in the circuit module design database 91 may include a plurality of the above-said circuits that differ with each other in their specifications.

It is notable that the circuit module design database 91 applicable in the present invention does not need to be a database wherein design information of all kinds of circuits is stored. It may be remote data storage, internet-accessible circuit design information storage or any storage means that is accessible through any kind of data transmission technology.

In other words, the circuit module design database 91 includes or made accessible design information of functional modules of at least two categories and each such category shall include design information of at least two kinds of circuit module that differ with each other in their specifications.

In the present invention, the element selection means 92 enables the designer to select suited functional modules with particular specifications from the circuit module design database 91. For example, when the designer is aware that the working circuit to be designed needs a memory of 1.25 Mb, the designer may choose a 1 Mb memory module and a 256 Kb memory module from the circuit module design database 91, instead of choosing 5 256 Kb memory modules or 1 1 Mb memory modules, as did in the conventional art.

Give another example. When the designer is aware that the power consumption of the working circuit to be designed is limited to the capacity of batteries and the requirements in the application, the designer may design an optimal allocation of the needed functional circuits.

Yet another example: When the designer wishes to design a working circuit to be manufactured under a budget, the designer may select a CPU core circuit of lower performance instead of a circuit of higher performance so to save unnecessary costs.

In order to facilitate the designer to select proper circuit modules from the circuit module design database 91, it is recommendable to provide a suggestion means (not shown) in the element selection means 92. The selection means automatically selects suited circuit modules from the circuit module design database 91, composes them into a plurality of combination of circuit modules according to specifications and requirements as input by the designer and presents the combinations to the designer as a candidate list, such that the designer may select from the candidates. Since to compose a plurality of circuit modules into a processing element to be used in a working circuit is a well-known technology, details description of the selection means will be omitted.

After the designer has selected the required element(s), the element selection means 92 includes the circuit design information of the selected modules or elements into the design information file of the working Circuit to be design according to features, specifications and other particular requirements, such as requirements in the process of manufacture, of the selected modules or elements. As to the technology of including selected circuit module design information into a working circuit, there are design tools commercially available in the industry, such as PKS (by Cadence Design Systems, Inc.) or Silicon Example (by Synopsys Inc.). Besides, anyone skilled in the art would find it easy to design such a tool for particular applications. Detailed description of such a design tool is thus omitted.

When the design information of all selected circuit elements the circuit module connection means 93 conducts the processing of connecting the selected circuit modules. The processing of connecting circuit modules includes defining the connections between and/or among circuit modules according to the requirements given by designers of the circuit modules or by the designer of the working circuit. The technology of connecting circuit modules is well-known in the industry and many tools to conduct such connection processing are commercially available in the industry, such as PKS and Silicon Example. Besides, it is also possible for those skilled in the art to design a bus structure allowing the transmission, reception, exchange of signals and data generated by respective circuit modules through the bus and applicable in the invented modularized circuit design information generating tool and method. Detailed description of the circuit module connection means 93 is thus omitted.

After the needed circuit modules are selected and their design information is included into the design information file of the working circuit to be designed, the obtained design information file represents the circuit design of the working circuit. The file converting means 95 converts the data in the obtained file into a format as desired, such that data of the converted file may be used in the simulation of circuit behaviors of the working circuit, included into a further large-scaled working circuit or even sent to a photo mask producer to produce photo masks for the working circuit. In the file converting means 95, the file converting program may be a commercially available product or a converting program provided by particular semiconductor factories. Since the file converting program is a known art, detailed description of the converting program will be omitted.

To make the modularized circuit design information generating tool of this invention easier to use, a user interface 96 may be provided optionally. The user interface 96 allows the designer to input selection factors, requirements and other necessary information in the design of the working circuit into the circuit design information generating tool of this invention and displays or otherwise outputs design information or diagnostic information of circuits so generated.

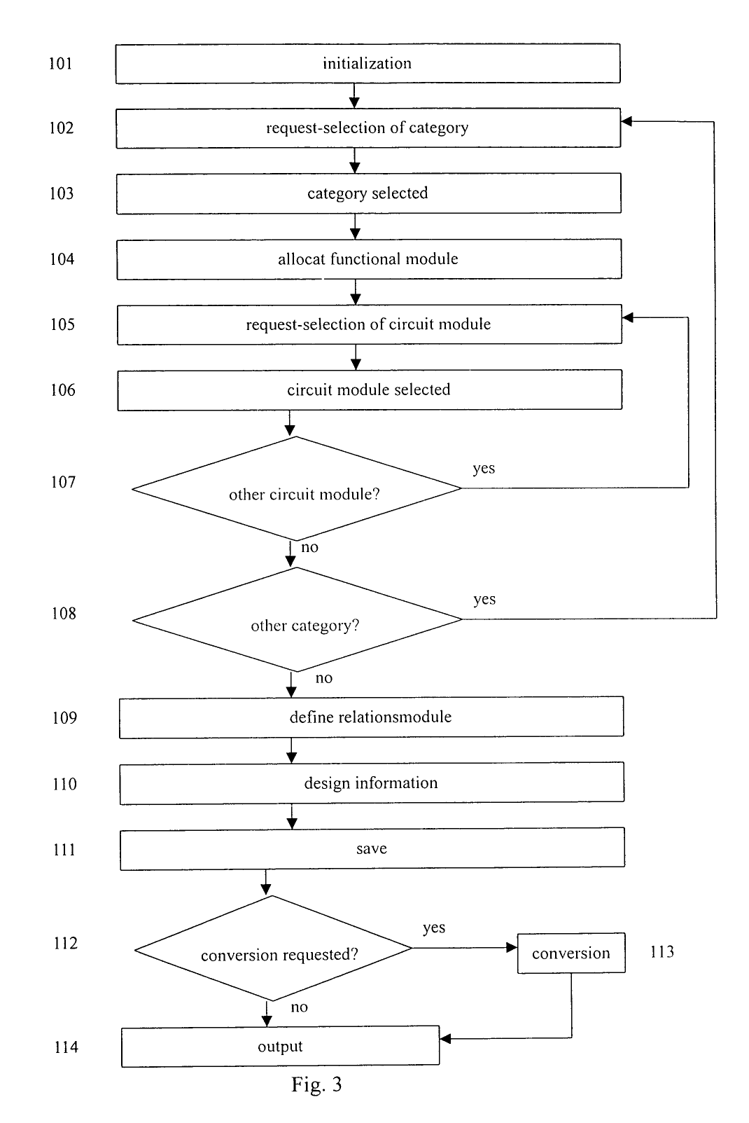

In the followings, the method of generating circuit design information using the modularized circuit design information generating tool of this invention will be described. FIG. 3 illustrates the flowchart of the modularized circuit design information generating method of this invention. As shown in the figure, at 101, the designer initializes the modularized circuit design information generating tool of this invention. At 102 the system requests the designer to select a category of functional module. The designer inputs a selection information of the selected category of the desired functional module at 103. At this stage, it is possible for the circuit design information tool to provide a list of candidate categories of functional module in the user interface 96, such that the designer may select one or more categories from the list. At 104 the system obtains useful information regarding the selected category from the circuit module design database 91 and requests the designer to select a circuit module from the circuit modules belonging to the selected category of functional module at 105. At this stage, it is possible for the system to provide a list of candidate circuit modules that belong to the selected category of functional module in the user interface 96, such that the designer may choose at least one of the circuit module from the list. In other embodiments of this invention, a composition means (not shown) is provided to request the designer to input applicable requirements and conditions and to select and compose possible combinations of circuit modules under the requirements and conditions input by the designer from the definite collection of circuit modules stored in the circuit module design database 91. By doing this, the composed combinations of circuit modules are listed and displayed in the user interface 96, allowing the designer to select.

At 106, the designer selects a circuit module or a combination of circuit module. The system determines whether the designer desires to select another circuit module or combination of circuit module at 107. If yes, the process returns to step 105; Otherwise, the system determines whether the designer desires to select another functional module at 108. If yes, the process returns to step 102; Otherwise, the circuit element connection means 93 defines the connections between and/or among the selected circuit modules at 109 and includes the design information and the connection information of the selected circuit modules into the design information file of the working circuit to be designed at 110. At 111 the design information and the connection information are stored in the memory 95. At 112 the system determines whether the obtained file needs to be converted. If yes, the file converting means 94 converts the design information of the working circuit into a format as required at 113 and outputs the converted file at 114; otherwise, the obtained file is output at 114. A working circuit is thus designed.

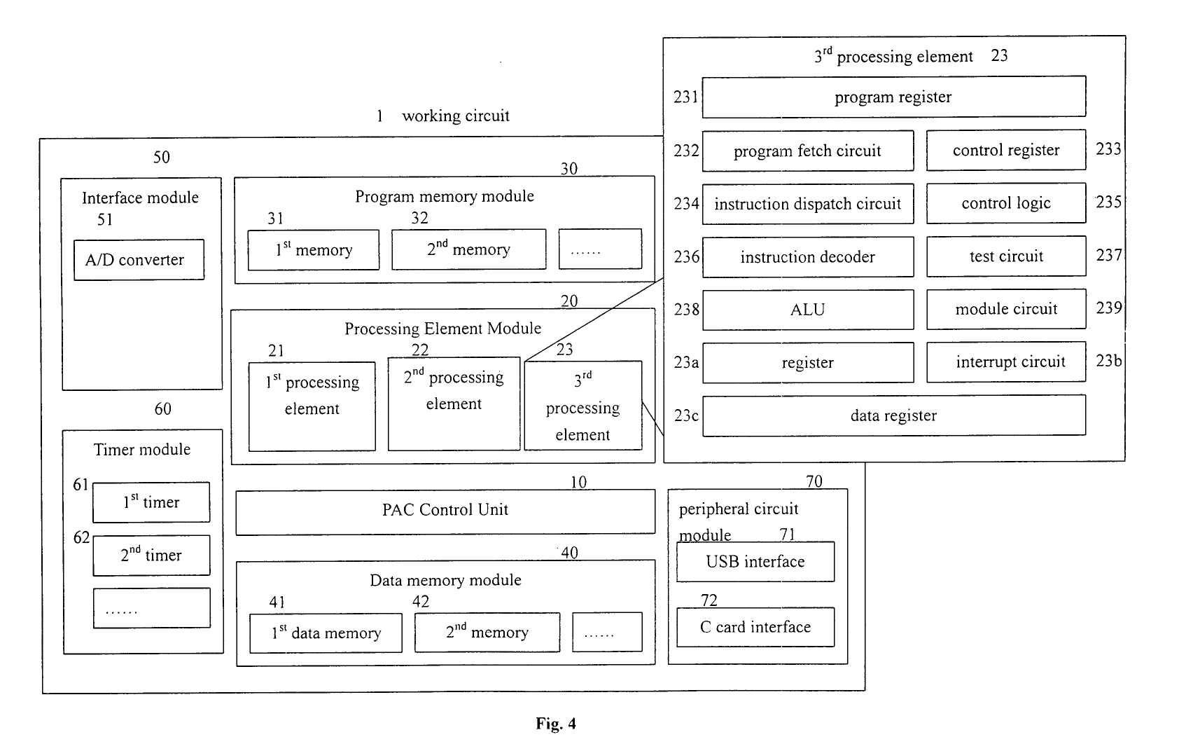

FIG. 4 shows the block diagram of a working circuit as designed according to the above-described process. The working circuit as shown in this figure is a relatively complicated circuit. In this figure, components that are the same as those in FIGS. 1 are labeled with same numbers. As shown in this figure, the working circuit so obtained includes:
A control unit 10.

A processing element module 20, including first processing element 21, second processing element 22, third processing element 23, and fourth processing element 24. Among them, the third processing element 23 further includes: a program register 231, a program fetch circuit 232, a control register 233, an instruction dispatch circuit 234, a control logic 235, an instruction decoder 236, a test circuit 237, an ALU 238, a module circuit 239, a register 23a, an interrupt circuit 23b and a data register 23c. In them, each processing element may be composed in a variety of combination of circuit modules. For example, useful processing elements may be codec, modem, image filter etc.

A program memory module 30, including first memory 31, second memory 32 etc.

A data memory module, including first data memory 41, second memory 42 etc.

An interface module 40, including an A/D converter 51, a D/A converter etc.

A timer module 60, including first timer 61, second timer 62 etc. And

A peripheral circuit module 70, including a USB interface 71 and a PC card interface 72.

The circuit modules which are used in the foregoing working circuit may be selected by the designer freely from the finite circuit modules available to the designer. Any designer is allowed to compose optimal combinations from the finite members of circuit modules in the circuit module design database. The present provides a simplified, reconfigurable, flexible and optimal process of circuit design.

### EMBODIMENT I

In the followings, several examples are given to illustrate how design information of working circuits is generated using the modularized circuit design information generating tool and the modularized circuit design information generating method of this invention.

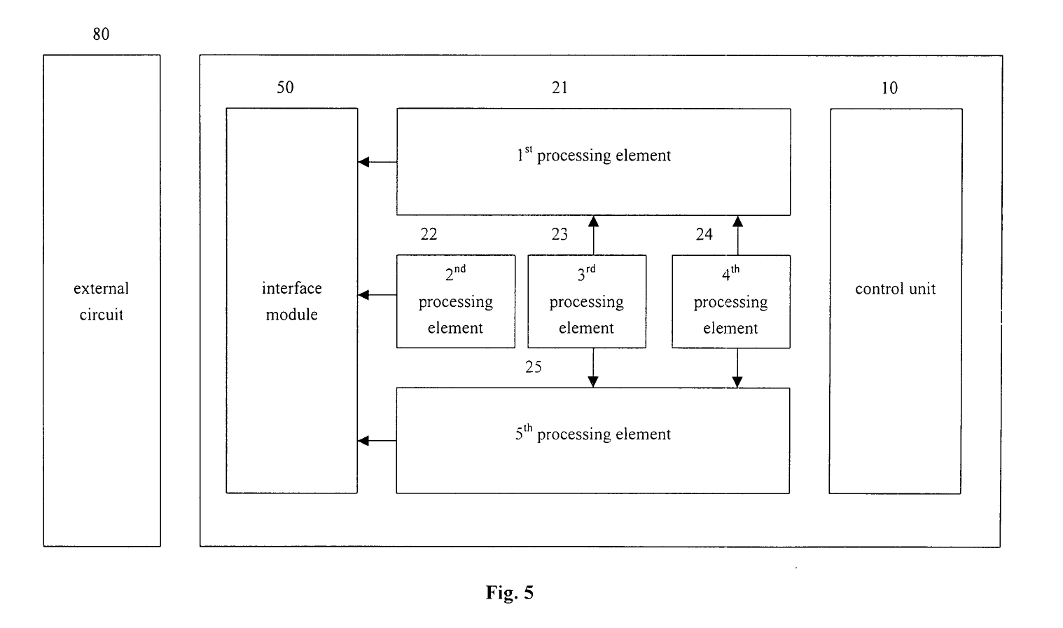

FIG. 5 illustrates a block diagram of a Bluetooth working circuit designed by the modularized circuit design information generating tool of this invention. In this figure, elements that are the same as those in FIGS. 1 and 4 are labeled with the same numbers.

In FIG. 5, 1 represents a Bluetooth working Circuit, 80 represents an external circuit; In the case indicated by FIG. 5, the external circuit 80 is a radio frequency IC. The Bluetooth working circuit 1 comprises 5 processing elements. They are: First processing element 21 is a packet composer to generate information packets complying with Bluetooth standard, second processing element 22 is a frequency hopping circuit to provide the function of frequency spread, third processing element 23 is a security control circuit to conduct all kinds of necessary processing in order to ensure communication security, including authentication, encryption etc., fourth processing element 24 is a codec to encode signals and data to be transmitted and to decode signals and data having been received and fifth processing element 25 is a packer decomposer to decompose information from the information packets.

In addition to the above, the working circuit also includes an interface module 50 to administrate the communications between the working circuit 1 and the radio frequency IC 80 and a control unit 10 to control the operation of all the functional circuit and modules.

The functional modules and the working element needed in the Bluetooth working circuit may be those already openly offered for license and their combination.

It is thus very easy for the designer to design a working circuit when the modularized circuit design information generating tool is used. The resulted working circuit will be an optimal combination of finite circuit modules as available.

### EMBODIMENT II

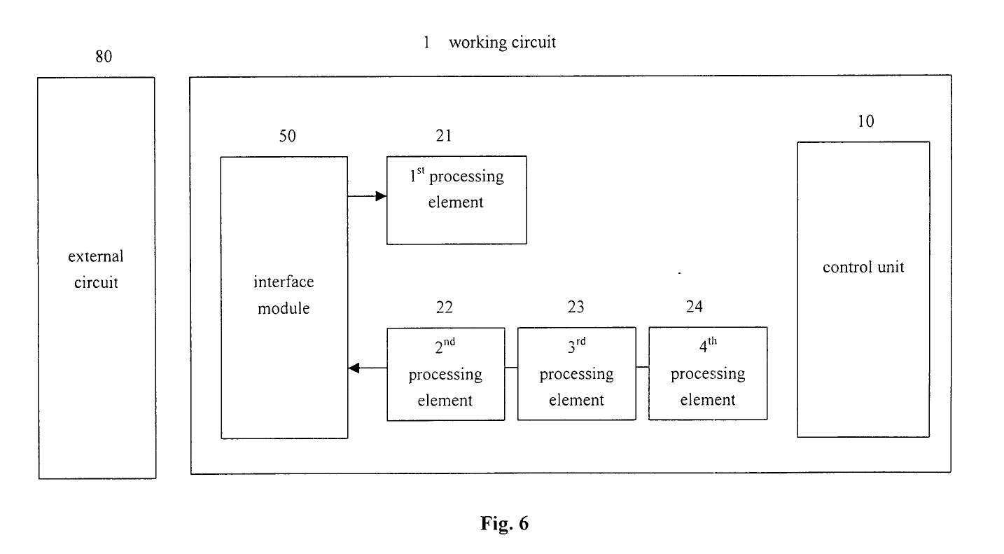

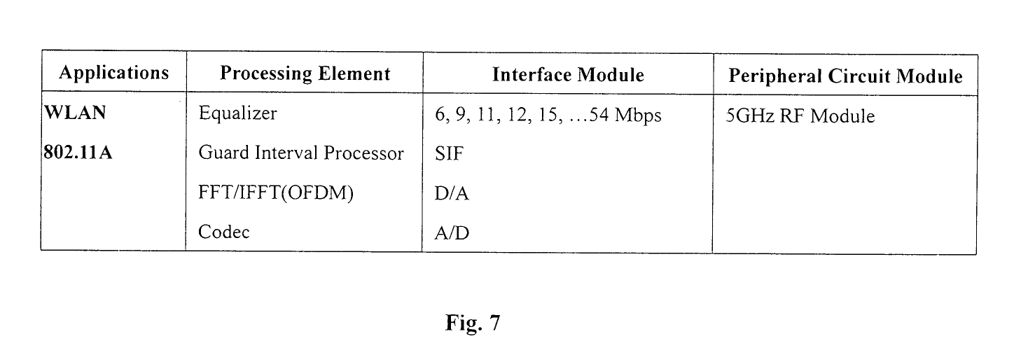

FIG. 6 illustrates the block diagram of an 802.11a wireless networking card circuit designed with the modularized circuit design information generating tool of this invention. Elements that are corresponding to those in FIG. 5 are labeled with same numbers. FIG. 7 shows a list of functional modules and circuit modules used in the circuit of FIG. 6.

As shown in FIG. 6, in the wireless networking card circuit comprises: 1 represents a working circuit of wireless networking card, 80 represents an external circuit; In the case indicated by FIG. 6, the external circuit 80 is a radio frequency IC. The working circuit 1 comprises 4 processing elements. They are: First processing element 21 is an equalizer to eliminate interferences or noises in the communications channel, second processing element 22 is a guard-interval processor to identify intervals between continuous packets, third processing element 23 is a Fourier transformer to perform Fourier transformation of received signals or signals to be transmitted and fourth processing element 24 is a codec to encode signals and data to be transmitted. The working circuit 1 further comprises an interface module 50 to perform communications administrations between the working circuit 1 and the external circuit 80 and a control unit 10 to control operations of all functional circuits and modules.

All circuits of these functional modules and processing elements may be selected from those ready for license in the market.

The modularized circuit design information generating tool of this invention may be used to design all kinds of circuit elements, including wireless communications circuit, networking circuit, digital signal processor, game circuit, data processors for all kinds of use, control circuit etc.

As the present invention has been shown and described with reference to preferred embodiments thereof, those skilled in the art will recognize that the above and other changes may be made therein without departing from the spirit and scope of the invention.

1. A modularized circuit design information generating tool, comprising
a circuit module design database including circuit design information of functional modules of at least two categories, wherein at least one category of said functional modules includes design information of circuit modules of at least two different specifications;
an element selection means allowing user to select suited circuit modules from said circuit module design database according to particular specifications of functional elements to be included into circuit to be designed and to include circuit design information corresponding to said selected circuit modules into circuit design information file of said circuit to be designed;
a circuit module connection means to define connections between or among selected circuit modules according to features of each selected circuit module;
a memory to store circuit design information of all selected circuit modules and information of connections between and/or among the selected circuit modules, both of circuit under design or circuit as designed; and
a file converting means to convert circuit design information so obtained into an applicable format.

2. The modulated circuit design information generating tool according to claim 1, wherein said circuit module design information database comprises a communications tool connectable to a remote database.

3. The modulated circuit design information generating tool according to claim 1, wherein said circuit design information database comprises a group of circuit design information file for central processing unit, a group of circuit design information file for processing element, a group of design information file for memory circuit and a group of circuit design information file for interfacing circuit.

4. The modulated circuit design information generating tool according to claim 3, wherein said group of circuit design information file for central processing unit comprises core circuit design information for at least two central processing units different in operational speed, length in instruction or bus width with each other.

5. The modulated circuit design information generating tool according to claim 3, wherein said group of circuit design information for processing circuit comprises circuit design information for at least two processing elements different in function.

6. The modulated circuit design information generating tool according to claim 5, wherein said group of circuit design information for processing circuit comprises circuit design information for at least one codec, at least one filter and at least one modulator.

7. The modulated circuit design information generating tool according to claim 3, wherein said group of circuit design information for memory circuit comprises circuit design information for at least two types of memory different in memory space.

8. The modulated circuit design information generating tool according to claim 3, wherein said group of circuit design information for interfacing circuit comprises circuit design information for at least two interfacing circuits different in function.

9. The modulated circuit design information generating tool according to claim 8, wherein said group of circuit design information for interfacing circuit comprises circuit design information for at least one A/D converter, at least D/A converter, a USB interface circuit and a PCMCIA interface circuit.

10. A modularized circuit design information generating method, comprising:
selecting suited circuit modules according to particular specifications of functional elements to be included into circuit to be designed from a circuit module design database including circuit design information of functional modules of at least two categories, wherein at least one category of said functional modules includes design information of circuit modules of at least two different specifications
including circuit design information corresponding to said selected circuit modules into circuit design information file of said circuit to be designed;
defining connections between or among selected circuit modules according to features of each selected circuit module; and
converting circuit design information so obtained into an applicable format.

11. The modulated circuit design information generating method according to claim 10, wherein said circuit module design information database comprises a communications tool connectable to a remote database.

12. The modulated circuit design information generating method according to claim 10, wherein said circuit design information database comprises a group of circuit design information file for central processing unit, a group of circuit design information file for processing element, a group of design information file for memory circuit and a group of circuit design information file for interfacing circuit.

13. The modulated circuit design information generating method according to claim 12, wherein said group of circuit design information file for central processing unit comprises core circuit design information for at least two central processing units different in operational speed, length in instruction or bus width with each other.

14. The modulated circuit design information generating method according to claim 12, wherein said group of circuit design information for processing circuit comprises circuit design information for at least two processing elements different in function.

15. The modulated circuit design information generating method according to claim 14, wherein said group of circuit design information for processing circuit comprises circuit design information for at least one codec, at least one filter and at least one modulator.

16. The modulated circuit design information generating method according to claim 12, wherein said group of circuit design information for memory circuit comprises circuit design information for at least two types of memory different in memory space.

17. The modulated circuit design information generating method according to claim 12, wherein said group of circuit design information for interfacing circuit comprises circuit design information for at least two interfacing circuits different in function.

18. The modulated circuit design information generating method according to claim 17, wherein said group of circuit design information for interfacing circuit comprises circuit design information for at least one A/D converter, at least D/A converter, a USB interface circuit and a PCMCIA interface circuit.

19. A memory stored with circuit design information generated from the method of any of claims 10-18.

20. A circuit prepared with circuit design information generated from the method of any of claims 10-18.
